(19) United States
(12) Patent Application Publication
(10) Pub. No.: US 2025/0328489 A1
(43) Pub. Date: Oct. 23, 2025

(54) INTERACTION METHOD AND DEVICE

(71) Applicant: Lenovo (Beijing) Limited, Beijing (CN)

(72) Inventors: Hua ZHANG, Beijing (CN); Tong WANG, Beijing (CN); Chao XU, Beijing (CN)

(21) Appl. No.: 19/178,602

(22) Filed: Apr. 14, 2025

(30) Foreign Application Priority Data
Apr. 17, 2024 (CN) 202410466154.3

(51) Int. Cl. G06F 16/11; G06F 40/30

(52) U.S. Cl. CPC G06F 16/11; G06F 40/30

(57) ABSTRACT

An interaction method includes obtaining input information, obtaining, in response to the input information and based on a target response type, output information that meets a matching condition with the input information, and outputting the output information. The target response type is used in determination of at least one of a source of the output information or a method of determining the output information.

### CROSS-REFERENCE TO RELATED APPLICATION

This application claims priority to Chinese Patent Application No. 202410466154.3, filed on Apr. 17, 2024, the entire content of which is incorporated herein by reference.

### TECHNICAL FIELD

The present disclosure generally relates to the field of interaction technologies and, more particularly, to an interaction method and device.

### BACKGROUND

Solutions for users to obtain information from electronic devices through human-computer interaction are usually not flexible enough and cannot well meet the interaction needs of users.

### SUMMARY

In accordance with the disclosure, there is provided an interaction method including obtaining input information, obtaining, in response to the input information and based on a target response type, output information that meets a matching condition with the input information, and outputting the output information.

Also in accordance with the disclosure, there is provided an electronic apparatus including a memory storing a computer program, and a processor configured to execute the computer program to obtain input information, obtain, in response to the input information and based on a target response type, output information that meets a matching condition with the input information, and output the output information. The target response type is used in determination of at least one of a source of the output information or a method of determining the output information.

Also in accordance with the disclosure, there is provided non-transitory computer-readable storage medium storing a computer program that, when executed by a processor, causes the processor to obtain input information, obtain, in response to the input information and based on a target response type, output information that meets a matching condition with the input information, and output the output information. The target response type is used in determination of at least one of a source of the output information or a method of determining the output information.

### BRIEF DESCRIPTION OF THE DRAWINGS

FIG. 1A is a flow chart of an interaction method consistent with embodiments of the present disclosure.

FIG. 1B is a schematic structural diagram showing the display of a first display area in a first state consistent with embodiments of the present disclosure.

FIG. 1C is a schematic diagram showing the display of a first display area and a second display area in a second state consistent with embodiments of the present disclosure.

FIG. 1D is another schematic diagram showing the display of a first display area and a second display area in a second state consistent with embodiments of the present disclosure.

FIG. 1E is a schematic diagram showing the display of a file added to an information set in a file manager consistent with embodiments of the present disclosure.

FIG. 1F is a schematic diagram showing a first display area consistent with embodiments of the present disclosure.

FIG. 1G is a schematic diagram showing the display of a first display area and a second display area in a third state consistent with embodiments of the present disclosure.

FIG. 1H is a schematic diagram showing interaction for obtaining output information during an edition process of a fifth file consistent with embodiments of the present disclosure.

FIG. 2A is a flow chart of another interaction method consistent with embodiments of the present disclosure.

FIG. 2B is a schematic diagram showing vectorizing files by a knowledge base in an interaction method consistent with embodiments of the present disclosure.

FIG. 2C is a schematic diagram showing automatic update of a knowledge base in an interaction method consistent with embodiments of the present disclosure.

FIG. 2D is another schematic diagram showing automatic update of a knowledge base in an interaction method consistent with embodiments of the present disclosure.

FIG. 3 is a schematic structural diagram of an interaction device consistent with embodiments of the present disclosure.

FIG. 4 is a schematic structural diagram of an electronic apparatus consistent with embodiments of the present disclosure.

### DETAILED DESCRIPTION OF THE EMBODIMENTS

Embodiments of the present disclosure are described hereinafter with reference to the accompanying drawings. The described embodiments are only some of the embodiments of the present disclosure, and not all of the embodiments. Based on the embodiments in the present disclosure, all other embodiments obtained by those skilled in the art without creative work are within the scope of the present disclosure.

In the present disclosure, the terms “first/second/third” involved are merely used to distinguish similar objects and do not represent a specific ordering of the objects. It is understandable that “first/second/third” may be interchanged with a specific order or sequence where permitted, such that the embodiments of the present disclosure described herein may be implemented in an order other than that illustrated or described herein. Unless otherwise defined, all technical and scientific terms used herein have the same meaning as those commonly understood by those skilled in the art to which the present disclosure belongs. The terms used herein are only for the purpose of describing the present disclosure and are not intended to limit the scope of the present disclosure. It should also be noted that, for ease of description, only the parts related to the relevant application are shown in the accompanying drawings.

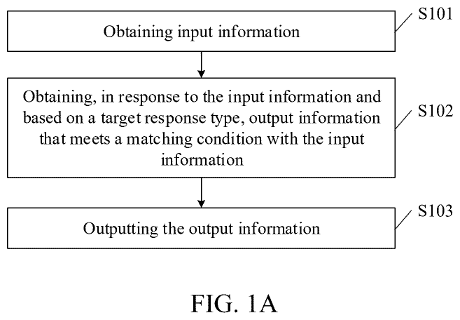

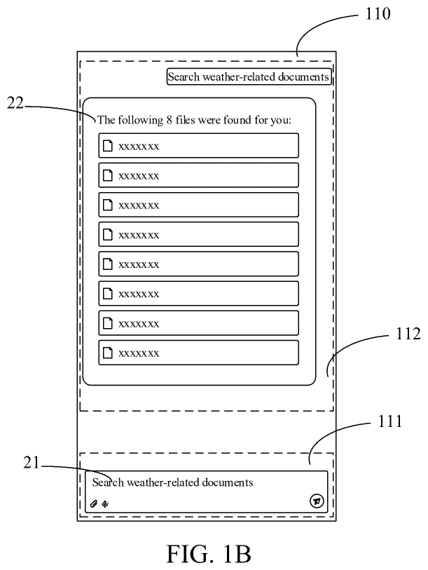

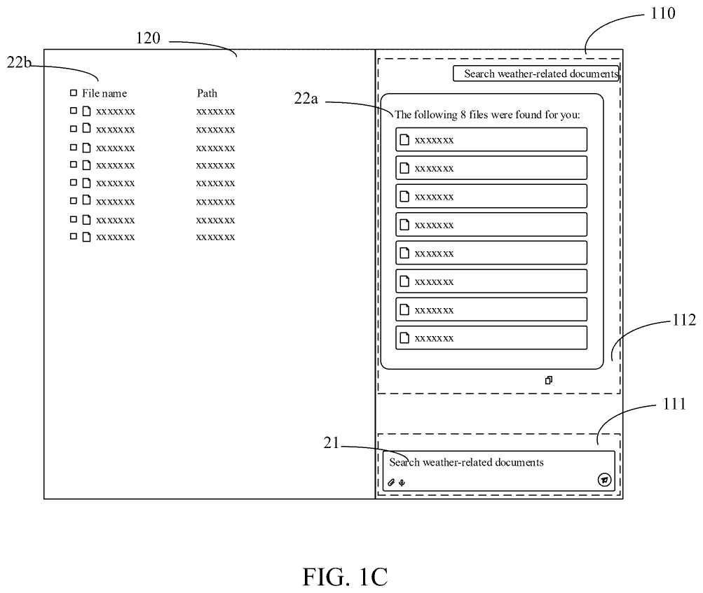

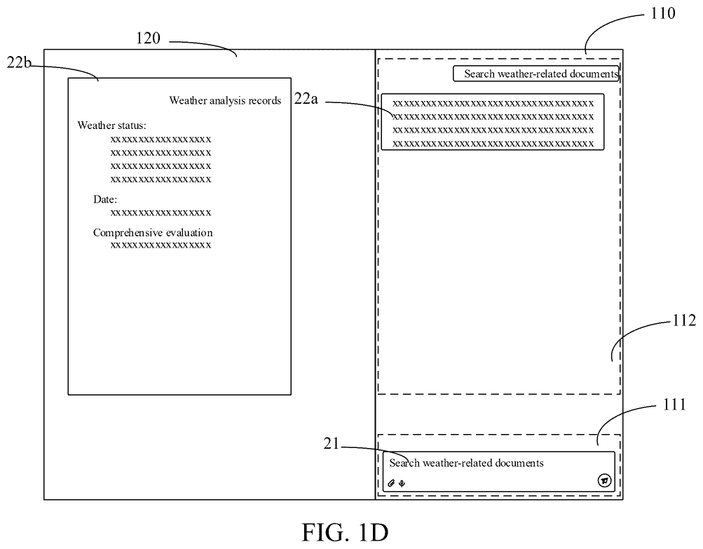

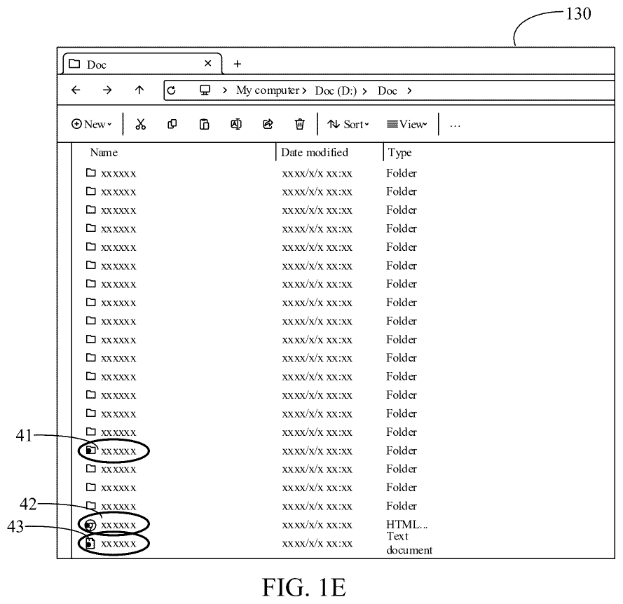

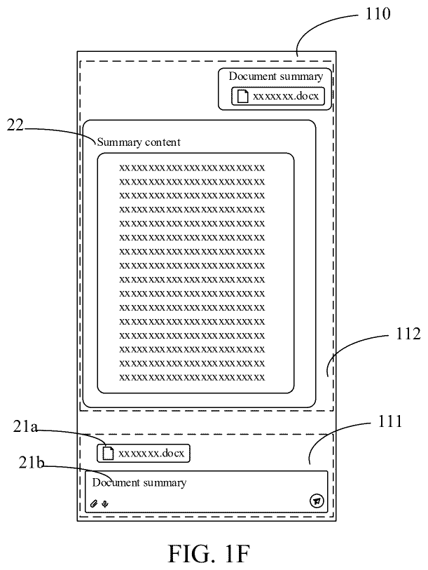

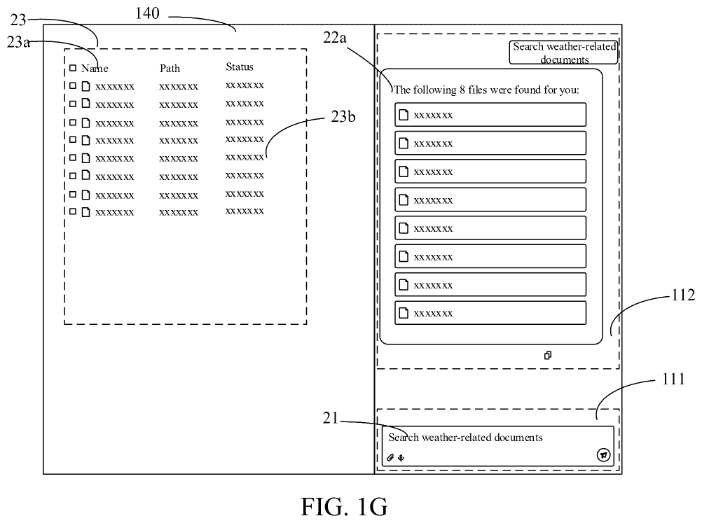

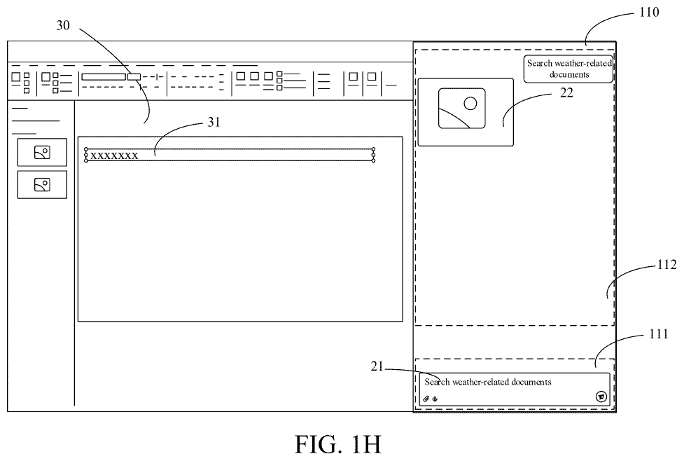

The present disclosure provides an interaction method. The interaction method may be executed by an electronic apparatus. FIG. 1A is a flow chart of an interaction method consistent with embodiments of the present disclosure. As shown in FIG. 1A, in one embodiment, the interaction method includes S101 to S103 described below.

At S101, input information is obtained.

The input information may include but is not limited to at least one of voice information, text information, image information, instruction information, etc.

The input information may be obtained in any suitable manner, which is not limited here.

In some embodiments, the input information may be obtained in response to a user's information input operation. The information input operation may include but is not limited to at least one of a voice input operation, a text typing operation, a text selection operation, an image acquisition operation, etc.

In some embodiments, the input information may be automatically generated by an artificial intelligence large model.

In some embodiments, the input information may include but is not limited to information or keywords that represent the user's intention. For example, the user's intention may include but is not limited to the retrieval of content information, questioning of existing knowledge, chatting, acquisition of device configuration parameters, and/or acquisition of application configuration parameters, etc.

At S102, in response to the input information, based on a target response type, output information that meets a matching condition with the input information is obtained, where the target response type is used to determine an acquisition source of the output information and/or a determination method of the output information.

The output information that meets the matching condition with the input information may be obtained according to the acquisition source and/or determination method corresponding to the target response type. The target response type may be set by the user according to the actual interaction needs, or may be determined based on the input information, which is not limited by the present disclosure.

In some embodiments, the target response type may include at least one of a first type, a second type, or a third type. The first type may represent obtaining the output information corresponding to the input information based on an information set. The second type may represent obtaining the output information corresponding to the input information based on system information. The third type may represent generating the output information corresponding to the input information based on a processing model. The information set may include but is not limited to at least one of a database, a knowledge base, a folder, etc. The system information may include relevant information of the system itself (such as hardware configuration information, and/or system operation parameters, etc.), and/or relevant information of an application running on the system (such as application configuration information, and/or application operation parameters, etc.).

The output information may include any suitable information that meets the matching condition with the input information. For example, when the input information is search information, the output information may include search result information that matches the search information. When the input information is target input information for existing knowledge, the output information may include answer information for the target input information. When the input information is instruction information, the output information may include execution result information of the instruction information, etc.

In some embodiments, the source of the output information may include but is not limited to local and/or cloud.

In some embodiments, determining the output information may include, but is not limited to, searching and determining based on the information set, searching and determining based on the system information, and/or analyzing and determining the input information using a processing model.

At S103, the output information is output.

Outputting the output information may include, but is not limited to, displaying part or all of the output information on an interface, or obtaining part or all of the output information through voice playback and sending part or all of the output information to the device and/or application.

In the embodiment of the present disclosure, the output information that meets the matching condition with the input information may be obtained based on the target response type. Therefore, since the target response type is used to determine the source of the output information and/or the method of determining the output information, the output information may be provided to the user more flexibly through different target response types, thereby better meeting the user's interaction needs.

In some embodiments, the interaction method may further include at least one of S104 to S105 described below.

At S104, the target response type is determined based on the input information.

In some embodiments, the target response type may be obtained by parsing the input information. For example, when the input information is text information input by the user, the target response type may be determined after keyword extraction and/or semantic analysis of the text information.

In some embodiments, an initial value of the target response type may be determined as the first type, and the first type may represent the output information corresponding to the input information obtained based on the information set. Correspondingly, when the target response type is the initial value, the output information that meets the matching condition with the input information may be retrieved from the information set. When there is no output information that meets the matching condition with the input information in the information set, the target response type may be updated to the second type, and the second type may represent the output information corresponding to the input information generated based on the processing model. The processing model may include, but is not limited to, a combination of one or more models such as a large language model or a semantic recognition model that is able to recognize user input information. For example, the information set may be a knowledge base. When the output information that meets the matching condition with the input information cannot be obtained from the knowledge base, a template answer may be provided based on the processing model.

Therefore, based on the input information, the target response type that better matches the input information may be determined, such that output information that better matches the input information may be obtained to better meet the user's interaction needs.

At S105, in response to a type setting operation, a set target response type is obtained.

The type setting operation may be any suitable operation that is able to set the target response type, which is not limited here.

In some embodiments, the type setting operation may be an operation performed by the user when entering the input information. In some other embodiments, the type setting operation may be an operation performed by the user in advance before entering the input information.

In some embodiments, the type setting operation may be an operation of selecting the target response type through a function button of a pre-set interactive interface. In some other embodiments, after obtaining the input information, the input information may be parsed, and the parsed result may be matched with a pre-set target response type list to obtain the target response type that matches the target response type list.

Therefore, the user may conveniently and flexibly set the target response type through the type setting operation according to actual needs, such that the obtained output information may better meet the user's interaction needs.

In some embodiments, the interaction method may further include S106 to S107.

At S106, in a first state, a first display area is displayed, a first sub-area of the first display area displays input information, a second sub-area of the first display area displays output information, where the second sub-area is a portion of the first display area that is different from the first sub-area.

At S107, in a second state, the first display area and a second display area are displayed, adjacent edges between the second display area and the first display area satisfy a matching relationship, the first sub-area of the first display area displays input information, the second sub-area of the first display area displays a first part of the output information, and the second display area displays a second part of the output information. In this disclosure, adjacent edges between two areas can refer to an edge of one area and an edge of the other area that are adjacent to each other. For example, adjacent edges between a first area and a second area can be an edge of the first area that is closest to the second area among all edges of the first area and an edge of the second area that is closest to the first area among all edges of the second area. Two edges satisfying the matching relationship can mean, for example, the two edges are parallel or approximately parallel to each other and have a same length. In some embodiments, adjacent edges between two areas satisfying the matching relationship can mean the two areas touch each other and one of the adjacent edges at least partially overlaps with the other one of the adjacent edges and, in the case the adjacent edges completely overlap with each other, the adjacent edges are in fact one line, i.e., the boundary between the two areas.

The display position of the first display area and the layout of the first sub-area and the second sub-area in the first display area may be determined according to actual conditions, and the present disclosure does not limit this.

The first display area, the second display area, and/or a third display area described below may be displayed on a display screen, or may be displayed on a preset entity (such as a wall, and/or a curtain, etc.) by projection or the like, or may be virtually displayed through augmented reality, virtual reality, etc., which is not limited here.

In the first state, the first display area may be displayed, but the second display area may not be displayed. For example, as shown in FIG. 1B, in the first state, the first display area 110 may be displayed, the first sub-area 111 of the first display area 110 may display the input information 21, and the second sub-area 112 of the first display area 110 may display the output information 22.

In the second state, the first display area and the second display area may be displayed simultaneously. The first display area and the second display area may be displayed adjacent to each other. For example, the first display area and the second display area may be adjacent to each other horizontally or vertically, which is not limited here. As shown in FIG. 1C and FIG. 1D, in one embodiment, in the second state, the first display area 110 and the second display area 120 are displayed, and the adjacent edges between the second display area 120 and the first display area 110 satisfy the matching relationship. The first sub-area 111 of the first display area 110 displays the input information 21, the second sub-area 120 of the first display area 110 displays the first part 22a of the output information, and the second display area 120 displays the second part 22b of the output information.

The first part and the second part of the output information may be the same, different, or partially the same.

In some embodiments, the first sub-area of the first display area may include a text box and/or a voice input button. When the user inputs the input information, the input text information and/or the text information obtained after the voice information is recognized may be displayed in the text box of the first sub-area of the first display area.

In some embodiments, a content extension control may be provided in the second sub-area of the first display area. When the second sub-area of the first display area displays the folded part of the output information, in response to the triggering operation of the content extension control, the complete output information may be displayed in the second sub-area of the first display area.

In some embodiments, the output information may be displayed only in the second sub-area of the first display area; or, a part of the output information may be displayed in the second sub-area of the first display area and another part of the output information other than the part of the output information displayed in the first display area may be displayed in the second display area.

For example, when the output information includes the file content in the knowledge base, the file content and/or the file list corresponding to the file content may be displayed only in the first display area; or, a part of the file content and/or the file list corresponding to the file content may be displayed in the first display area, and the whole file content and/or the file list corresponding to the file content may be displayed in the second display area.

As another example, when the output information includes knowledge content from the cloud, the knowledge content and the source website list corresponding to the knowledge content may be displayed only in the first display area; or, the knowledge content and the source website list corresponding to the knowledge content may be displayed in the first display area, and, the source website list, source website, web page information, etc. corresponding to the knowledge content may be displayed in the second display area.

As another example, when the output information includes system file configuration parameters, the system file configuration parameters may be displayed only in the first display area; or, the system file configuration parameters may be displayed in the first display area, the system configuration file associated with the system file configuration parameters, the file content of the system configuration file, etc. may be displayed in the second display area.

In some embodiments, based on the target response type, obtaining the output information that meets the matching condition with the input information (S102), may include at least one of S111 to S113 described below.

At S111, when the target response type includes the first type, based on the information set, the output information corresponding to the input information is obtained, where the information set includes the file information and the processing information of the file corresponding to the file information, and the output information includes the content information, file information and/or positioning link information of the target file that meets the matching condition with the input information.

The content information of the target file may include text information, image information, etc., and the target file may be the source file corresponding to the output information.

The processing information of the file may include file feature information obtained after processing the file, which may include but is not limited to keywords extracted from the file, file vectors obtained after vectorizing the file, etc.

In some embodiments, when the file information includes the address of the file corresponding to the file information, the output information may include positioning link information determined based on the address of the target file, and the positioning link information may be positioning information that may link to the source file and open the source file, and may include text form or icon form, such as shortcut files, hyperlinks, etc.

In some embodiments, the information set may be stored locally or in the cloud. When the information set is stored locally, there may be no need to upload the file to the cloud, which may improve the privacy of the files in the information set.

In some embodiments, the file information included in the information set and the processing information of the file corresponding to the file information may be pre-added by the user according to the interaction requirements. Therefore, the personalization of the file information in the information set may be improved, thereby better meeting the personalized interaction requirements of the user.

At S112, when the target response type includes the second type, based on the system information, the output information corresponding to the input information is obtained, where the output information includes parameter information and/or instruction information that meets the matching condition with the input information.

The second type may include but is not limited to querying system information, querying configuration information, obtaining control instructions for devices and/or applications, etc.

The system information may include system-related information or information related to applications running on the system. The parameter information may include but is not limited to system parameters, application parameters, etc., such as: computer memory size, file save path in the application, etc.

In some embodiments, the instruction information may include control instructions for devices and/or applications.

In some embodiments, after obtaining the instruction information that meets the matching condition of the input information, the instruction included in the instruction information may also be executed, and the execution result of the instruction may be obtained. The output information corresponding to the input information may include the execution result.

At S113, when the target response type includes the third type, based on the processing model, the output information corresponding to the input information is generated, where the output information includes dialogue reply content for the input information.

The third type includes that the processing model answers based on the initial answering ability, and the processing model may include an artificial intelligence large model, a large language model, etc.

In some embodiments, the processing model may provide a template answer matching the input information based on the input information.

In some embodiments, the target response type may be switched and/or combined based on different input information. For example, when the output information that meets the matching condition with the input information cannot be obtained from the information set, the template answer matching the input information may be generated based on the processing model.

In the embodiments of the present disclosure, when the target response type includes the first type, the output information corresponding to the input information may be obtained based on the information set; when the target response type includes the second type, the output information corresponding to the input information may be obtained based on the system information; and, when the target response type includes the third type, the output information corresponding to the input information may be generated based on the processing model. Therefore, on the one hand, by searching the files added or retrieved in the information set according to the user's personalized needs and generating the personalized output information, the practicality and accuracy of the output information may be improved; and, on the other hand, different output information may be output based on different target response types, which may improve the efficiency and accuracy of users in obtaining information.

In some embodiments, the target response type may include the first type, and the interaction method may further include at least one of S108 to S110 described below.

At S108, in response to the first file information of the first file being added to the information set, the first positioning link information of the first file and the first processing information after processing the file content of the first file may be obtained, and the first file information, the first positioning link information and the first processing information may be associatively added to the information set. In this disclosure, associatively adding A and B to C can mean associating A with B and adding associated A and B to C.

The first file may be the source file corresponding to the newly added file information in the information set, the first positioning link information may be the positioning link information of the first file, and the first processing information may be the file processing information of the first file.

In some embodiments, adding the first file information of the first file to the information set may include: selecting the first file in the file manager interface of the system, right-clicking to open the function list, and selecting the option of adding the file to the information set in the function list to add it.

In some other embodiments, adding the first file information of the first file to the information set may also include: opening the file management interface of the information set, and selecting the first file from the file manager of the system in the file adding area of the file management interface of the information set.

In some embodiments, a first scheduled task for regularly monitoring the file information in the information set may be set to respond to the addition of the first file information of the first file to the information set. When the first scheduled task monitors the addition of the first file information in the information set, an event of adding the first file information may be triggered, and the first file information and the first positioning link information may be associatively added to the information set.

In some embodiments, the file information may include the first file status information, and the first file status information may indicate that the first file information of the first file has been added to the information set. After the event of adding the first file information is triggered, the first scheduled task may obtain the first positioning link information, generate the first file status information, and associatively add the first file information including the first file status information and the first positioning link information to the information set.

In some embodiments, in response to adding the first file information of the first file to the information set, the display icon of the first file in the file manager may be modified, an information identifier may be added to the original display icon of the first file in the file manager, and the information identifier may indicate that the file information of the first file has been successfully added to the information set. As shown in FIG. 1E, in the file manager interface 130 of the system, the file information of files 41, 42, and 43 has been added to the information set.

In some embodiments, a second scheduled task for regularly monitoring the file information in the information set may be set, and when the second scheduled task monitors the addition of the first file status information in the information set, the event of adding the first file status information may be triggered.

In some embodiments, after the event of adding the first file status information is triggered, the first file may be processed to generate the first file processing information. The first file information, the first positioning link information, and the first processing information may be associatively added to the information set;

In some embodiments, the file information may include second file status information, and the second file status information may be added to the information set as the latest file status information of the first file, where the second file status information may indicate that the first file processing information of the first file has been generated and added to the information set.

In some embodiments, the file information may include third file status information, and the third file status information may be added to the information set as the latest file status information of the first file, where the third file status information indicates that the first file processing information of the first file has not been successfully generated.

In some embodiments, the first file may be a file or a folder.

In some embodiments, when the first file is a folder, the file processing information of the first file may include the file processing information obtained by processing all files in the first file separately.

At S109, in response to the update of the second file corresponding to the second file information in the information set, the file content of the updated second file is processed to obtain the second processing information corresponding to the second file, and the processing information associated with the second file information in the information set is updated to the second processing information.

When the information set includes the second file information of the second file and the processing information corresponding to the second file, it may be necessary to reprocess the file content of the updated second file to obtain the updated processing information when the file content of the second file is updated, i.e., the second processing information, and update the second processing information to the information set. Therefore, the processing information associated with the second file information in the information set may be updated to the second processing information, such that more accurate output information may be obtained based on the updated information set.

At S110, in response to the deletion of the third file information in the information set or the deletion of the third file corresponding to the third file information, the third positioning link information and the third processing information associated with the third file information are deleted from the information set.

When the information set includes the third file information of the third file and the processing information corresponding to the third file, the third positioning link information and the third processing information associated with the third file information in the information set may become invalid if the third file information or the third file in the information set is deleted. Therefore, the third positioning link information and the third processing information associated with the third file information may be deleted from the information set.

In some embodiments, files (i.e., source files) corresponding to each file information in the information set may be monitored by a scheduled task to see whether they are updated and/or deleted, and the file information in the information set may also be monitored by a scheduled task to see whether it is deleted.

In some embodiments, the target response type may include the first type, the input information may include the fourth file information in the information set and the target input information for the fourth file information. Correspondingly, based on the information set, obtaining the output information corresponding to the input information (S111), may include:

S121, based on the fourth processing information associated with the fourth file information in the information set, obtaining the output information that satisfies the matching relationship with the target input information.

The target input information may include but is not limited to at least one of question information, processing instruction information, etc. The question information may be, for example, “What is the central idea of this article,” “Who is the author of this file,” etc. The processing instruction information may be, for example, “Summarize the full text,” “Find paragraphs related to a certain keyword,” etc.

For example, as shown in FIG. 1F, in one embodiment, the user may input the fourth file information 21a and the target input information 21b for the fourth file information 21a in the first sub-area 111 of the first display area 110, and, after obtaining the output information 22 that satisfies the matching relationship with the target input information 21b, the output information 22 may be displayed in the second sub-area 112.

In some embodiments, S121 may include:

S141, when the first language used in the file content of the fourth file corresponding to the fourth file information is different from the second language used in the target input information, adjusting the language of the target input information to the first language;

S142, obtaining, based on the fourth processing information associated with the fourth file information in the information set, the intermediate information that matches the adjusted target input information;

S143, adjusting the language of the intermediate information to the second language, to obtain the output information that matches the target input information.

Adjusting the language of the target input information to the first language may only include the translation of the target input information, that is, translating the target input information into the first language. In some embodiments, after the target input information is translated into the first language, the adjusted target input information may be subjected to natural language processing, such as language error correction, and/or text polishing, etc.

Therefore, cross-language information interaction may be achieved to better meet the interaction needs of users and bring better user experience to users.

In some embodiments, the target response type may include the first type, and the interaction method may further include:

S120, in the third state, displaying the first display area and the third display area, where: the first sub-area of the first display area displays the input information, the second sub-area of the first display area, which is a part of the first display area different from the first sub-area, displays the output information, and the third display area displays the file information list added to the information set and the content processing status of the file corresponding to each file information in the file information list which represents the state of processing the file content of the file.

In the third state, the first display area and the third display area may be displayed at the same time. The third display area may be the same as the second display area, or different from the second display area, which is not limited here.

In some embodiments, the third display area may be displayed adjacent to the first display area, and the adjacent edges between the third display area and the first display area may satisfy the matching relationship. For example, the third display area and the first display area may be adjacent to each other horizontally or vertically, which is not limited here.

In some embodiments, the content processing status may include at least one of pending, processing, processing completed, processing failed, etc.

For example, as shown in FIG. 1G, in the third state, the first display area 110 and the third display area 140 may be displayed. The first sub-area 111 of the first display area 110 displays input information 21, the second sub-area 112 of the first display area 110 displays output information 22, and the third display area 140 displays the file information list 23 added to the information set and the content processing status 23b of the file corresponding to each file information 23a in the file information list.

In some embodiments, the content processing status of the file corresponding to each file information in the information set may be cached, such that the query efficiency of the content processing status may be improved and the waiting time of the user may be reduced when displaying the file information list added to the information set and the content processing status of the file corresponding to each file information in the file information list.

In some embodiments, S101 may include:

S130, in response to the content query operation performed during the editing process of the fifth file, obtaining query information, and using the query information as the input information.

S101 may also include:

S140, adding part or all of the output information to the fifth file.

The fifth file may include but is not limited to a file containing text, and/or pictures or other contents.

The content query operation may include but is not limited to at least one of a query operation based on the currently edited part of the content in the fifth file, a query operation based on the input information entered by the user in the first sub-area of the first display area, etc.

In some embodiments, the content query operation may include a query operation based on the currently edited part of the content in the fifth file, and the query information may include the part of the content.

In some embodiments, the content query operation may include a query operation based on the input information entered by the user in the first sub-area of the first display area, and the query information may include the input information.

After obtaining the output information that satisfies the matching relationship with the input information, part or all of the output information may be added to the fifth file. The adding position of part or all of the output information in the fifth file is not limited.

In some embodiments, part or all of the output information may be inserted into the currently edited position in the fifth file.

In some other embodiments, the position where part or all of the output information is added in the fifth file may be determined based on the input information.

For example, as shown in FIG. 1H, when the input information is the title 31 of the target page 30 in the fifth file, the output information 22 that matches the title 31 may be obtained, and part or all of the output information 22 may be added to the target page 30.

As another example, when the input information is a selected portion of content in the fifth file, the output information that matches the selected portion of content may be obtained, and the selected portion of content may be replaced with part or all of the output information.

In some embodiments, after obtaining the output information, part or all of the output information may be directly added to the fifth file.

In some embodiments, after obtaining the output information, in response to the user's add trigger operation, part or all of the output information may be added to the fifth file.

In some embodiments, after obtaining the output information, in response to the user's information selection operation, the selected portion of the output information may be added to the fifth file.

In one embodiment, in response to the content query operation performed during the editing process of the fifth file, query information may be obtained, and the query information may be used as input information. After obtaining output information that matches the input information, part or all of the output information may be added to the fifth file. Therefore, auxiliary editing of text may be achieved, bringing a better interactive experience to users.

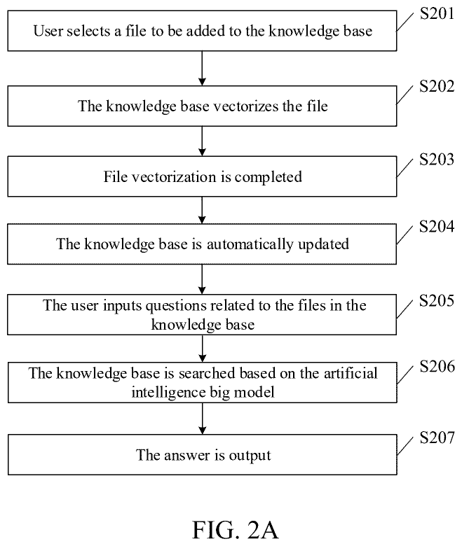

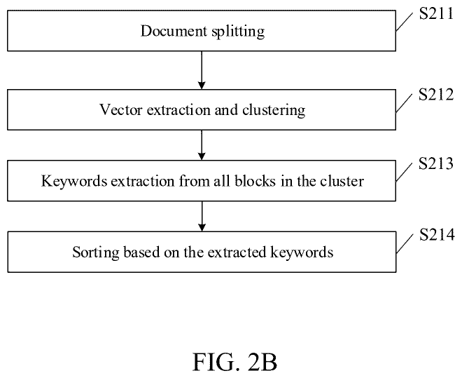

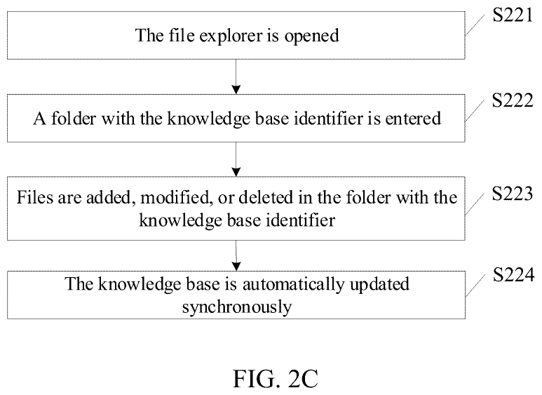

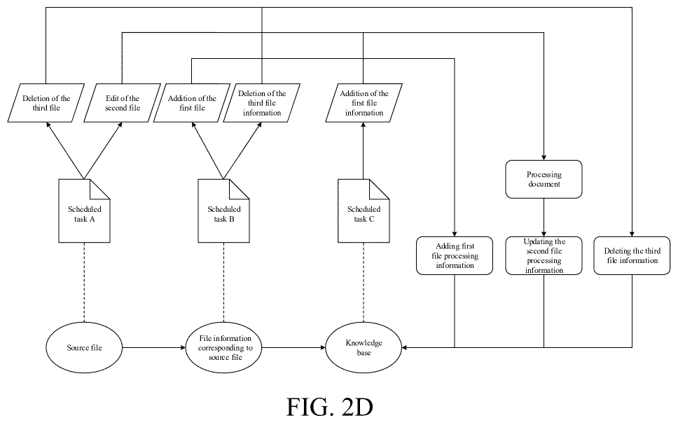

The present disclosure also provides an interaction method that may be applied to an electronic apparatus. FIG. 2A is a flow chart of an interaction method consistent with the present disclosure. As shown in FIG. 2A, the method includes S201 to S207 described below.

S201, the user selects a file to be added to the knowledge base.

The file selected by the user to be added to the knowledge base may correspond to the first file in the above-mentioned interaction method. In response to adding the first file information of the first file to the knowledge base, the first positioning link information of the first file may be obtained, and the first file information and the first positioning link information may be associatively added to the knowledge base.

In some embodiments, when the first file information and the first positioning link information have been associatively added to the knowledge base, the first file status information may be generated, and the first file status information may be associatively added to the knowledge base.

S202, the knowledge base vectorizes the file.

In response to monitoring that the first file information including the first file status information and the first positioning link information have been associatively added to the knowledge base, the first file may be vectorized to obtain a file vector, the first file processing information may be generated, and the first file information, the first positioning link information and the first processing information may be associatively added to the knowledge base.

S203, file vectorization is completed.

In some embodiments, when the first file is successfully processed, the second file status information may be generated, and the second file status information may be updated as the status information of the first file to the first file information in the knowledge base. When the first file is not successfully processed, the third file status information may be generated, and the third file status information may be updated as the status information of the first file to the first file information in the knowledge base.

S204, the knowledge base is automatically updated.

In response to the update of the file information in the knowledge base, the knowledge base may automatically update file information, position link information associated with the file information, and file processing information associated with the file information.

S205, the user inputs questions related to the files in the knowledge base.

In the first sub-area of the first display area of the electronic device, the user may enter questions related to the files in the knowledge base.

S206, the knowledge base is searched based on the artificial intelligence large model.

In response to the questions input by the user, the artificial intelligence large model may retrieve and obtain files matching the questions raised by the user from the knowledge base.

In some embodiments, feature extraction may be performed based on keywords in the questions input by the user, and the features may be converted into feature vectors, which are matched with the file vectors in the knowledge base.

S207, the answer is output.

In the second sub-area of the first display area of the electronic device, the artificial intelligence large model may display the file content matching the questions raised by the user and the file list corresponding to the file content.

As shown in FIG. 2B, in one embodiment, S202 may include S211 to S214 described below.

At S211, document splitting is performed.

The document corresponding to the file may be split into multiple blocks.

At S212, vector extraction and clustering are performed.

An encoder may be used to extract feature vectors for each block, and the extracted feature vectors may be clustered using a clustering algorithm to obtain multiple clusters.

In some embodiments, an embedding method may be used to extract feature vectors for each block.

At S213, keywords are extracted from all blocks in the cluster.

Keywords may be extracted from all blocks in the clusters obtained after clustering.

In some embodiments, a large language model may be used for each cluster to extract block keywords from all blocks in the cluster, and each block may correspond to multiple block keywords.

At S214, sorting is performed based on the extracted keywords.

The block keywords extracted in S213 may be sorted.

In some embodiments, the TF-IDF (term frequency-inverse document frequency, a weighted method based on term frequency and inverse text frequency index) method may be used to extract document-level document keywords based on all block keywords.

In some embodiments, a large language model may be used to extract article-level article keywords based on all block keywords, such as keywords in the fields of literature, technology, and society.

In some embodiments, the keywords corresponding to the vectorized document may include document keywords and/or article keywords.

In some embodiments, as shown in FIG. 2C, S204 may include S221 to S224 described below.

At S221, the file explorer is opened.

The user may open the file explorer in the system.

At S222, a folder with the knowledge base identifier is entered.

The user may determine whether the file information of the folder has been added to the knowledge base through the display icon corresponding to the folder displayed in the file explorer.

At S223, files are added, modified, or deleted in the folder with the knowledge base identifier.

The user may add, modify, or delete files in the folder with the knowledge base identifier through the file explorer, or open the file management page of the knowledge base through the artificial intelligence model to add or delete files in the folder in the knowledge base.

At S224, the knowledge base is automatically updated synchronously.

As shown in FIG. 2C, when the scheduled task A monitors the deletion of the third file corresponding to the third file information in the knowledge base, the third file information, the third positioning link information associated with the third file information, and the third processing information are deleted from the information set, and the scheduled task A corresponds to the second scheduled task in the above-mentioned interactive method.

When the scheduled task A monitors the update of the second file corresponding to the second file information in the knowledge base, the file content of the updated second file is processed to obtain the second processing information corresponding to the second file, and the processing information associated with the second file information in the knowledge base is updated to the second processing information;

When the scheduled task B monitors the addition of the first file information of the first file in the knowledge base, the first positioning link information of the first file and the first processing information after processing the file content of the first file are obtained, and the first file information, the first positioning link information, and the first processing information are associatively added to the knowledge base. The scheduled task B corresponds to the first scheduled task in the above interaction method.

When the scheduled task B monitors the deletion of the third file information in the knowledge base, the third positioning link information and the third processing information associated with the third file information are deleted from the knowledge base.

When the scheduled task C monitors that the first file status information of the first file in the knowledge base has been added, the instruction to vectorize the file may be passed to the file analysis model by passing the instruction. After the file vectorization is completed, the file processing information may be stored in the knowledge base, and the file status information of the first file may be updated from the first file status information to the second file status information and stored in the knowledge base. The scheduled task C may correspond to the third scheduled task in the above interaction method.

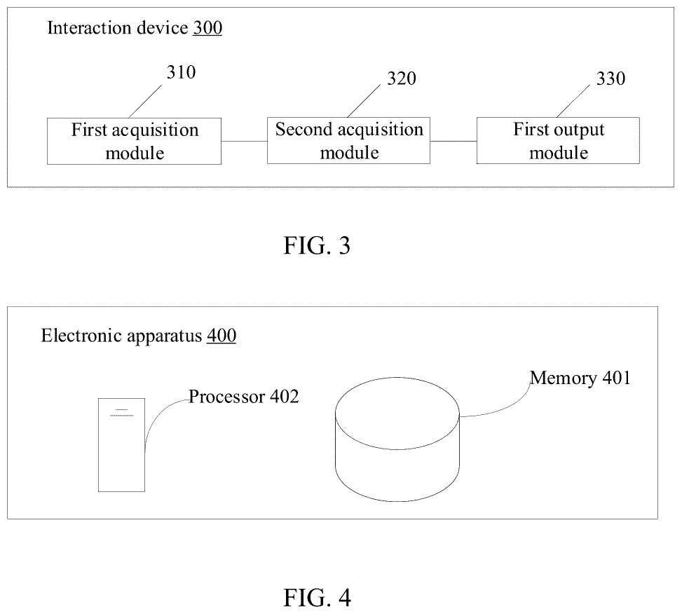

The present disclosure also provides an interaction device. FIG. 3 is a schematic structural diagram of an interaction device consistent with the present disclosure. As shown in FIG. 3, in one embodiment, the interaction device 300 includes:
a first acquisition module 310, configured to obtain input information;
a second acquisition module 320, configured to respond to the input information and obtain output information that meets a matching condition with the input information based on a target response type, where the target response type is used to determine an acquisition source of the output information and/or a determination method of the output information; and
a first output module 330, configured to output the output information.

In some embodiments, the interaction device may further include a first display module, configured to:
in a first state, display a first display area, such that a first sub-area of the first display area displays the input information and a second sub-area of the first display area displays the output information, where the second sub-area is a part of the first display area that is different from the first sub-area; and
in a second state, display the first display area and a second display area, where: the adjacent edges between the second display area and the first display area meet the matching relationship, the first sub-area of the first display area displays the input information, the second sub-area of the first display area displays a first part of the output information, and the second display area displays a second part of the output information.

In some embodiments, the second acquisition module may be further configured to perform at least one of:
when the target response type includes the first type, based on an information set, obtaining the output information corresponding to the input information, where the information set includes file information and processing information of the file corresponding to the file information, and the output information includes content information, file information and/or positioning link information of the target file that meets the matching conditions with the input information;
when the target response type includes the second type, based on the system information, obtaining the output information corresponding to the input information, where the output information includes parameter information and/or instruction information that meets the matching condition with the input information; or
when the target response type includes the third type, based on the processing model, obtaining the output information corresponding to the input information, where the output information includes the dialogue reply content for the input information.

In some embodiments, the target response type may include the first type, and the interaction device may further include a first response module, which is configured to perform at least one of:
in response to adding the first file information of the first file to the information set, obtaining the first positioning link information of the first file and the first processing information after processing the file content of the first file, and associatively adding the first file information, the first positioning link information and the first processing information to the information set;
in response to the update of the second file corresponding to the second file information in the information set, processing the file content of the updated second file to obtain the second processing information corresponding to the second file, and updating the processing information associated with the second file information in the information set to the second processing information; or
in response to the deletion of the third file information in the information set or the deletion of the third file corresponding to the third file information, deleting the third positioning link information and the third processing information associated with the third file information from the information set.

In some embodiments, the target response type may include the first type, and the second acquisition module may also be further configured to: obtain the output information that satisfies the matching relationship with the target input information based on the fourth processing information associated with the fourth file information in the information set.

In some embodiments, the second acquisition module may be further configured to: when the first language used in the file content of the fourth file corresponding to the fourth file information is different from the second language used in the target input information, adjust the language of the target input information to the first language; based on the fourth processing information associated with the fourth file information in the information set, obtain intermediate information that satisfies the adjusted target input information; and adjust the language of the intermediate information to the second language to obtain the output information that satisfies the matching relationship with the target input information.

In some embodiments, the target response type may include the first type, and the interaction device may further include a second display module, which is configured to: in the third state, display the first display area and a third display area, such that the first sub-area of the first display area displays the input information, the second sub-area of the first display area displays the output information, and the third display area displays the file information list added in the information set and the content processing status of the files corresponding to each file information in the file information list, where the second sub-area is the part of the first display area different from the first sub-area and the content processing status represents the status of processing the file content of the file.

In some embodiments, the interaction device may further include a third acquisition module, which is configured to: determine the target response type based on the input information; and acquire the set target response type in response to a type setting operation.

In some embodiments, the first acquisition module may be further configured to: respond to the content query operation performed during the editing process of the fifth file, obtain query information, and use the query information as the input information.

In some embodiments, the first acquisition module may be further configured to add part or all of the output information to the fifth file.

The present disclosure also provides an electronic apparatus, including: a memory and a processor. FIG. 4 is a schematic structural diagram of an electronic apparatus consistent with the present disclosure. As shown in FIG. 4, in one embodiment, the electronic apparatus 400 includes a memory 401 and a processor 402.

The memory 401 is configured to store a computer program that is able to be executed in the processor 402.

The processor 402 is configured to execute the computer program stored in the memory 401 to implement the interaction method applied to an interactive device provided by any embodiments of the present disclosure.

The electronic apparatus may include but is not limited to one or more devices with data processing capabilities such as servers, laptops, tablet computers, desktop computers, or mobile devices (such as mobile phones, portable video players, personal digital assistants, dedicated messaging devices, portable gaming devices).

The present disclosure also provides a computer program, including computer-readable code. When the computer-readable code is executed in an electronic apparatus, a processor in the electronic apparatus may execute some or all of steps of the interaction method provided by any embodiments of the present disclosure.

The present disclosure also provides a computer program product, including a computer program or an instruction, which, when executed by a processor, implements some or all of steps of the interaction method provided by any embodiments of the present disclosure.

The present disclosure also provides a computer-readable storage medium, which stores a computer program, where the computer program may be executed by a processor to implement the interaction method provided by any embodiments of the present disclosure.

The present disclosure is described with reference to the flowchart and/or block diagram of the method and device according to the embodiments of the present disclosure. It should be understood that each process and/or box in the flowchart and/or block diagram, as well as the combination of the processes and/or boxes in the flowchart and/or block diagram may be implemented by computer program instructions. These computer program instructions may be provided to a processor of a general-purpose computer, a special-purpose computer, an embedded processor or another programmable data processing device to form a machine, such that the instructions executed by the processor of the computer or other programmable data processing device form a device for implementing the functions specified in one or more processes in the flowchart and/or one or more boxes in the block diagram.

These computer program instructions may also be stored in a computer-readable memory that is able to guide a computer or other programmable data processing device to work in a specific manner, such that the instructions stored in the computer-readable memory produce a product including an instruction device, which implements the functions specified in one or more processes of the flowchart and/or one or more boxes of the block diagram.

These computer program instructions may also be loaded onto a computer or other programmable data processing device, such that a series of operation steps are performed on the computer or other programmable device to produce computer-implemented processing, such that the instructions executed on the computer or other programmable device provide steps for implementing the functions specified in one or more processes of the flowchart and/or one or more boxes of the block diagram.

The above is only specific embodiments of the present disclosure, but the protection scope of the present disclosure is not limited thereto. Any changes or replacements that can be easily thought of by those skilled in the art disclosed in the present disclosure should be covered within the protection scope of the present disclosure.

The description of the above device embodiments is similar to the description of the above method embodiments, and has similar beneficial effects as the method embodiments. For technical details not disclosed in the device embodiments of the present disclosure, references may be made to the description of the method embodiments of the present disclosure for understanding.

It should be understood that the “one embodiment” or “some embodiments” mentioned throughout the specification means that the specific features, structures or characteristics related to the embodiments are included in at least one embodiment of the present disclosure. Therefore, “in one embodiment” or “in some embodiment” appearing throughout the specification does not necessarily refer to the same embodiment. In addition, these specific features, structures or characteristics may be combined in one or more embodiments in any suitable manner. It should be understood that in various embodiments of the present disclosure, the size of the sequence number of the above-mentioned processes does not mean the order of execution. The execution order of each process should be determined by its function and internal logic and should not constitute any limitation on the implementation process of the embodiments of the present disclosure. The above-mentioned sequence numbers of the embodiments of the present disclosure are only for description and does not represent the advantages and disadvantages of the embodiments.

It should be noted that in the present disclosure, the term “includes,” “comprises” or any other variant thereof is intended to cover non-exclusive inclusion, such that a process, method, article or device including a series of elements includes not only those elements, but may also include other elements not explicitly listed, or may also include elements inherent to such a process, method, article or device. In the absence of further restrictions, the elements associated with the phrase “includes one . . . ” do not exclude the existence of other identical elements in the process, method, article or device including the element.

It should be understood that the disclosed devices and methods may be implemented in other ways. The device embodiments described above are only schematic. For example, the division of the units is only a logical function division. There may be other division methods in actual implementation, such as: multiple units or components can be combined or can be integrated into another system, or some features can be ignored or not executed. In addition, the coupling, direct coupling, or communication connection between the components shown or discussed may be through some interfaces, and the indirect coupling or communication connection of the devices or units may be electrical, mechanical or other forms.

The units described above as separate components may or may not be physically separated, and the components shown as units may or may not be physical units. They may be located in one place or distributed on multiple network units. Some or all of the units may be selected according to actual needs to achieve the purpose of the scheme of the present disclosure.

In addition, all functional units in the embodiments of the present disclosure may be integrated into one processing unit, or each unit may be separately used as a unit, or two or more units may be integrated into one unit. The above integrated unit may be implemented in the form of hardware or in the form of hardware plus software functional units.

Those skilled in the art may understand that all or part of the steps of the above method embodiments may be completed by hardware related to program instructions, and the above program may be stored in a computer-readable storage medium. When the program is executed, the steps of the above method embodiments may be executed; and the above storage medium may include: a mobile storage device, a read-only memory (ROM), a magnetic disk or an optical disk, or other media that can store program codes.

Or, when the above integrated unit of the present disclosure is implemented in the form of a software functional module and sold or used as an independent product, it may also be stored in a computer-readable storage medium. Based on this understanding, the part in the technical solution of the embodiments of the present disclosure that essentially contributes to the relevant technology may be embodied in the form of a software product, which is stored in a storage medium and includes a number of instructions for enabling an electronic device (which can be a personal computer, server, or network device, etc.) to execute all or part of the methods described in each embodiment of the present disclosure. The aforementioned storage medium may include various media that can store program codes, such as mobile storage devices, ROMs, magnetic disks, or optical disks.

The above are only some embodiments of the present disclosure. It should be noted that for those of ordinary skill in the art, improvements and modifications can be made without departing from the principles of the present disclosure, and these improvements and modifications should also be regarded as being within the scope of the present disclosure.

What is claimed is:

1. An interaction method comprising:
obtaining input information;
obtaining, in response to the input information and based on a target response type, output information that meets a matching condition with the input information, the target response type being used in determination of at least one of a source of the output information or a method of determining the output information; and
outputting the output information.

2. The method according to claim 1, further comprising:
in a first state, displaying a first display area, the input information being displayed in a first sub-area of the first display area, the output information being displayed in a second sub-area of the first display area, and the second sub-area being a part of the first display area that is different from the first sub-area; and
in a second state, displaying the first display area and a second display area, adjacent edges between the second display area and the first display area satisfying a matching relationship, the input information being displayed in the first sub-area of the first display area, a first part of the output information being displayed in the second sub-area of the first display area, and a second part of the output information being displayed in the second display area.

3. The method according to claim 1, wherein obtaining the output information includes:
obtaining the output information based on an information set that includes file information and processing information of a file corresponding to the file information, the output information including at least one of content information, file information, or positioning link information of a target file that meets the matching condition with the input information.

4. The method according to claim 3, further comprising:
in response to first file information of a first file being added to the information set, obtaining positioning link information of the first file and first processing information after processing file content of the first file, and associatively adding the first file information, the positioning link information of the first file, and the first processing information to the information set;
in response to a second file corresponding to second file information in the information set being updated, processing file content of the second file after being updated to obtain second processing information corresponding to the second file, and updating processing information associated with the second file information in the information set to the second processing information; and
in response to third file information in the information set or a third file corresponding to the third file information being deleted, deleting positioning link information and third processing information associated with the third file information from the information set.

5. The method according to claim 3, wherein:
the input information includes file information in the information set and target input information for the file information; and
obtaining the output information includes:
obtaining, based on processing information associated with the file information in the information set, the output information that matches the target input information.

6. The method according to claim 5, wherein:
a first language used in file content of a file corresponding to the file information is different from a second language used in the target input information; and
obtaining, based on the processing information associated with the file information in the information set, the output information that matches the target input information, includes:
adjusting a language of the target input information to the first language;
obtaining, based on the processing information associated with the file information in the information set, intermediate information that matches the target input information that has been adjusted; and
adjusting a language of the intermediate information to the second language to obtain the output information that matches the target input information.

7. The method according to claim 3, further comprising:
displaying a first display area and a second display area;
wherein:
the input information is displayed in a first sub-area of the first display area;
the output information is displayed in a second sub-area of the first display area;
the second sub-area is a part of the first display area different from the first sub-area;
a list of file information added to the information set and content processing status of files corresponding to file information in the file information list are displayed in the second display area, the content processing status of one file representing a status of processing file content of the one file.

8. The method according to claim 1, wherein obtaining the output information includes:
obtaining the output information based on system information, the output information including at least one of parameter information or instruction information that meets the matching condition with the input information.

9. The method according to claim 1, wherein obtaining the output information includes:
generating the output information based on a processing model, the output information including dialogue reply content for the input information.

10. The method according to claim 1, further comprising:
determining the target response type based on the input information.

11. The method according to claim 1, further comprising:
obtaining a set response type as the target response type in response to a type setting operation.

12. The method according to claim 1, wherein obtaining the input information includes:
obtaining query information as the input information in response to a content query operation performed during an editing process of a file.

13. The method according to claim 12, further comprising:
adding part or all of the output information to the file.

14. An electronic apparatus comprising:
a memory storing a computer program; and
a processor configured to execute the computer program to:
obtain input information;
obtain, in response to the input information and based on a target response type, output information that meets a matching condition with the input information, the target response type being used in determination of at least one of a source of the output information or a method of determining the output information; and
output the output information.

15. The electronic apparatus according to claim 14, wherein the processor is further configured to execute the computer program to:
in a first state, display a first display area, the input information being displayed in a first sub-area of the first display area, the output information being displayed in a second sub-area of the first display area, and the second sub-area being a part of the first display area that is different from the first sub-area; and
in a second state, display the first display area and a second display area, adjacent edges between the second display area and the first display area satisfying a matching relationship, the input information being displayed in the first sub-area of the first display area, a first part of the output information being displayed in the second sub-area of the first display area, and a second part of the output information being displayed in the second display area.

16. The electronic apparatus according to claim 14, wherein the processor is further configured to execute the computer program to, when obtaining the output information:
obtain the output information based on an information set that includes file information and processing information of a file corresponding to the file information, the output information including at least one of content information, file information, or positioning link information of a target file that meets the matching condition with the input information.

17. The electronic apparatus according to claim 14, wherein the processor is further configured to execute the computer program to, when obtaining the output information:
obtain the output information based on system information, the output information including at least one of parameter information or instruction information that meets the matching condition with the input information.

18. The electronic apparatus according to claim 14, wherein the processor is further configured to execute the computer program to, when obtaining the output information:
generate the output information based on a processing model, the output information including dialogue reply content for the input information.

19. The electronic apparatus according to claim 14, wherein the processor is further configured to execute the computer program to:
determining the target response type based on the input information.

20. A non-transitory computer-readable storage medium storing a computer program that, when executed by a processor, causes the processor to:
obtain input information;
obtain, in response to the input information and based on a target response type, output information that meets a matching condition with the input information, the target response type being used in determination of at least one of a source of the output information or a method of determining the output information; and
output the output information.
